(19) United States
(12) Patent Application Publication
(10) Pub. No.: US 2024/0368797 A1
(43) Pub. Date: Nov. 7, 2024

(54) CERAMIC-LIKE LIGHT METAL ARTICLE AND METHOD FOR MANUFACTURING THE SAME

(71) Applicant: CATCHER TECHNOLOGY CO., LTD., TAINAN CITY (TW)

(72) Inventors: YUN-KAI HUANG, TAINAN CITY (TW); KUAN-CHUNK HUNG, TAINAN CITY (TW)

(21) Appl. No.: 18/650,321

(22) Filed: Apr. 30, 2024

(30) Foreign Application Priority Data
May 2, 2023 (TW) 112116233

(51) Int. Cl. C25D 11/02; B24B 1/00; C25D 11/22

(52) U.S. Cl. CPC C25D 11/024; B24B 1/00; C25D 11/22

(57) ABSTRACT

A method for manufacturing a ceramic-like light metal article includes the following steps. The first step is providing a light metal article and forming an anodized oxide layer on an outer surface of the light metal article. A next step is using a sandpaper with a grit number ranging from P500 to P10000 to polish the protective layer. The polished protective layer has a surface gloss of not less than 90 GU at a 60 degree angle and a surface roughness (Ra) of less than 0.1 μm. A ceramic-like light metal article obtained by using the method is further provided and exhibits a variety of color variations and a ceramic-like appearance.

### CROSS-REFERENCE TO RELATED PATENT APPLICATION

This application claims the benefit of priority to Taiwan Patent Application No. 112116233, filed on May 2, 2023. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a surface-treated light metal article and a method for manufacturing the same, and more particularly to a ceramic-like light metal article and a method for manufacturing the same.

### BACKGROUND OF THE DISCLOSURE

Light metals generally refer to metals with a density of less than 5 g/cm³. Current portable electronic products tend to have a thinner and lighter design. Light metals have become popular materials for housings and mechanical components of portable electronic devices due to its excellent physical and mechanical properties. To increase diversity in appearance and product functionality, light metal articles usually undergo a surface treatment, such as sandblasting, polishing, anodizing, or micro-arc oxidation (MAO).

CN 101591799 B discloses a surface polishing treatment method of magnesium alloy, which can increase the surface gloss of magnesium alloy materials. However, no film layer is formed on the surface of the polished magnesium alloy materials, thus resulting in poor corrosion resistance.

CN 1392295 A discloses forming a silver-gray smooth film layer on a magnesium or magnesium alloy surface by an anodizing treatment, so as to have an aesthetic appearance. However, the silver-gray smooth film layer is incapable of meeting the appearance requirements of various colors of products.

CN 101311326 A discloses forming a black oxide film layer on a light metal surface by micro-arc oxidation. However, the black oxide film layer is incapable of allowing for different color effects and different gloss variations of the light metal surface.

CN 107190301 A discloses forming an oxide film layer on a titanium or titanium alloy surface by an anodizing treatment and changing the color effect of the oxide film layer by operating voltage and current. However, the thickness of the film layer is difficult to control in such an operation and may result in poor color stability.

### SUMMARY OF THE DISCLOSURE

In response to the above-referenced technical inadequacies, the present disclosure provides a method for manufacturing a ceramic-like light metal article, which can allow for ceramization of an outer surface of the light metal article while giving it a high gloss by anodizing, surface coating, and polishing treatments. The present disclosure further provides a ceramic-like light metal article obtained by using said method.

In one aspect, the present disclosure provides a method for manufacturing a ceramic-like light metal article, which includes: providing a light metal article; forming an anodized oxide layer on an outer surface of the light metal article, in which the anodized oxide layer has a plurality of pores extending towards the outer surface of the light metal article; forming a protective layer on the anodized oxide layer; and using a sandpaper with a grit number ranging from P500 to P10000 to polish the protective layer, in which the polished protective layer has a surface gloss of not less than 90 GU at a 60 degree angle and a surface roughness (Ra) of less than 0.1 μm.

In one of the possible or preferred embodiments, the grit number of the sandpaper used in the step of polishing the protective layer is P2000.

In one of the possible or preferred embodiments, in the step of polishing the protective layer, a thickness of the polished protective layer is reduced to 20% to 80% of an original thickness of the protective layer.

In one of the possible or preferred embodiments, between the step of forming the anodized oxide layer and the step of forming the protective layer, the method further includes a step of filling the pores of the anodized oxide layer with at least one dye. Furthermore, in the step of forming the protective layer, a portion of the protective layer is filled into and seals the pores of the anodized oxide layer.

In one of the possible or preferred embodiments, an anodizing treatment is performed in an electrolytic solution with a pH value ranging from 8 to 13 and a temperature ranging from 5° C. to 40° C. to form the anodized oxide layer, and the electrolytic solution includes an oxidant, a pH adjusting agent, and a film-forming agent.

In one of the possible or preferred embodiments, the oxidant is selected from the group consisting of sodium nitrate, potassium nitrate, potassium permanganate, and potassium dichromate. The pH adjusting agent is selected from the group consisting of sodium hydroxide, potassium hydroxide, lithium hydroxide, and magnesium hydroxide. The film-forming agent is selected from the group consisting of sodium silicate, aluminum hydroxide, ammonium dihydrogen phosphate, sodium hexametaphosphate, and trisodium phosphate.

In one of the possible or preferred embodiments, the anodizing treatment is a pulse-type anodizing treatment, which includes a voltage gradual-rise stage followed by a constant-voltage stage. An operating voltage of the voltage gradual-rise stage increases from an initial voltage to a target voltage, and an operating voltage of the constant-voltage stage is maintained at the target voltage.

In one of the possible or preferred embodiments, the pulse-type anodizing treatment is performed with a pulse frequency from 500 Hz to 2,000 Hz and a duty cycle from 1% to 50%, the initial voltage is 0V, and the target voltage is from 50V to 600V. Furthermore, a duration of time of the voltage gradual-rise stage is from 1 minute to 10 minutes, and a duration of time of the constant-voltage stage is from 5 minutes to 60 minutes and more than twice the duration of time of the voltage gradual-rise stage.

In one of the possible or preferred embodiments, the protective layer is formed from a resin composition including an acrylic resin and a solid powder. The solid powder is a powder of a metal, a non-metal, or an oxide of the metal or non-metal, and a solid content of the resin composition is from 3 wt % to 30 wt %. The protective layer is formed by an electric hole-sealing treatment that is performed at an operating voltage from 1V to 150V for 30 seconds to 10 minutes.

In one of the possible or preferred embodiments, the step for forming the protective layer further includes baking the resin composition at a temperature from 100° C. to 200° C. for 15 minutes to 60 minutes.

In another aspect, the present disclosure provides a ceramic-like light metal article, which includes a light metal article, an anodized oxide layer, and a protective layer. The anodized oxide layer is formed on an outer surface of the light metal article, and has a plurality of pores extending towards the outer surface of the light metal article. The protective layer is formed on the anodized oxide layer to seal the pores, and has a surface gloss of not less than 90 GU at a 60 degree angle and a surface roughness (Ra) of less than 0.1 μm.

In conclusion, in the method for manufacturing a ceramic-like light metal article of the present disclosure, by virtue of forming an anodized oxide layer on an outer surface of the light metal article, forming a protective layer on the anodized oxide layer, using a sandpaper with a grit number ranging from P500 to P10000 to polish the protective layer, and the polished protective layer having a surface gloss of not less than 90 GU at a 60 degree angle and a surface roughness (Ra) of less than 0.1 μm, the light metal article can exhibit a variety of color variations and a ceramic-like appearance, thereby obtaining unique surface decoration effects.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a flowchart of a method for manufacturing a ceramic-like light metal article according to an embodiment of the present disclosure;

FIG. 2 is another flowchart of the method for manufacturing the ceramic-like light metal article according to the embodiment of the present disclosure;

FIG. 3 is a schematic view showing different operational stages of an anodizing treatment used in the method for manufacturing the ceramic-like light metal article according to the embodiment of the present disclosure;

FIG. 4 is a partial schematic view of a partial structure of the ceramic-like light metal article according to the embodiment of the present disclosure;

FIG. 5 is a partial schematic view of an entire structure of the ceramic-like light metal article according to the embodiment of the present disclosure; and

FIG. 6 is another partial schematic view of the entire structure of the ceramic-like light metal article according to the embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

Unless otherwise stated, the material(s) used in any described embodiment is/are commercially available material(s) or may be prepared by methods known in the art, and the operation(s) or instrument(s) used in any described embodiment is/are conventional operation(s) or instrument(s) generally known in the related art.

Although any steps shown in a flowchart are described herein in a specific order, the steps are not required or implied to be executed in the specific order or all executed to achieve desired results. In execution, it is optional to combine two or more steps into one step, or to divide one step into two or more steps.

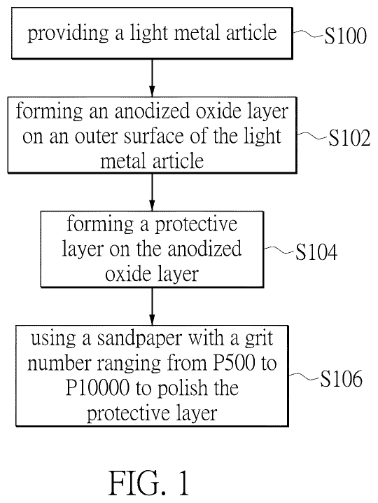

Referring to FIG. 1, an embodiment of the present disclosure provides a method for manufacturing a ceramic-like light metal article, which mainly includes: step S100, providing a light metal article; step S102, forming an anodized oxide layer on an outer surface of the light metal article; step S104, forming a protective layer on the anodized oxide layer; and step S106, using a sandpaper with a grit number ranging from P500 to P10000 to polish the protective layer. More specifically, the technical solution provided by the embodiment of the present disclosure can allow for ceramization of the outer surface of the light metal article while giving it a high gloss by anodizing, surface coating, and polishing treatments.

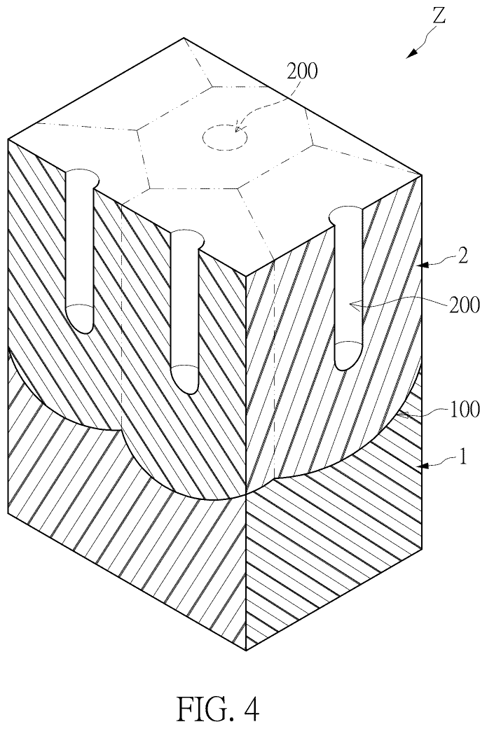

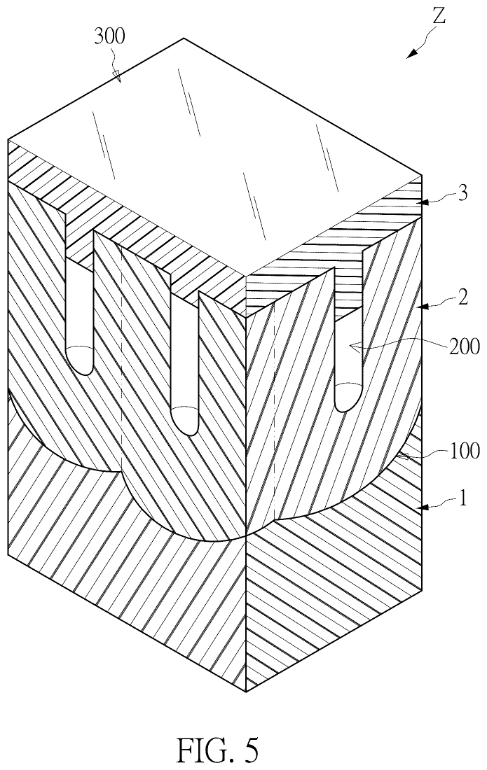

Referring to FIG. 4 and FIG. 5, a ceramic-like light metal article Z can be obtained after completing the steps as mentioned above, which includes a light metal article 1, an anodized oxide layer 2, and a protective layer 3. The light metal article 1 has an outer surface 100. The anodized oxide layer 2 is formed on the outer surface 100 of the light metal article 1, and has a plurality of pores 200 extending towards the outer surface 100 of the light metal article 1. The protective layer 3 is formed on the anodized oxide layer 2 and seals the pores 200. Furthermore, a surface 300 of the protective layer 3 has a gloss of not less than 90 GU at a 60 degree angle and a surface roughness (Ra) of less than 0.1 μm.

More details about each step of the method for manufacturing the ceramic-like light metal article are described below.

In step S100, the light metal article 1 can be made of aluminum, magnesium, titanium, or their alloys. Furthermore, the light metal article 1 can be shaped by using a variety of methods, such as casting, extruding, forging, and cutting, to have a shape (e.g., a sheeted shape) required for practical applications, such that it can be used for appearance parts (e.g., a casing) of electronic products.

In step S102, the anodized oxide layer 2 is a crystalline porous ceramic layer formed by an anodizing treatment. In an execution process, the light metal article 1 serves as an anode and is immersed in an alkaline electrolytic solution, a cathode is made of a corrosion-resistant material such as stainless steel, and specific operating conditions are used to promote the formation of the anodized oxide layer 2 that is well adhered on the entire outer surface 100 of the light metal article 1. In the embodiment of the present disclosure, the alkaline electrolytic solution includes an oxidant, a pH adjusting agent, and a film-forming agent, and has a pH value ranging from 8 to 13 and a temperature ranging from 5° C. to 40° C. In addition, the anodized oxide layer 2 has a thickness ranging from 3 μm to 50 μm, a uniform white or gray appearance, and a surface roughness (Ra) less than 1.0 μm.

The oxidant can be selected from the group consisting of sodium nitrate, potassium nitrate, potassium permanganate, and potassium dichromate. The pH adjusting agent can be selected from the group consisting of sodium hydroxide, potassium hydroxide, lithium hydroxide, and magnesium hydroxide. The film-forming agent can be selected from the group consisting of sodium silicate, aluminum hydroxide, ammonium dihydrogen phosphate, sodium hexametaphosphate, and trisodium phosphate. The content of each of the oxidant, the pH adjusting agent, and the film-forming agent can be reasonably adjusted according to performance requirements of the electrolytic solution. However, such examples are not meant to limit the scope of the present disclosure.

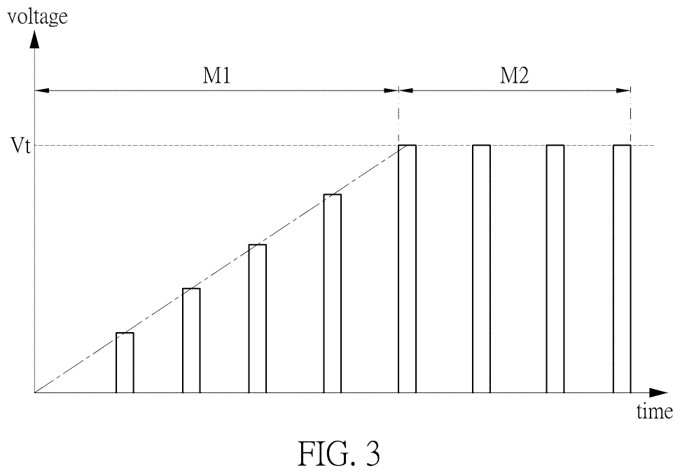

Referring to FIG. 3, the anodizing treatment is preferably a pulse-type anodizing treatment, which includes a voltage gradual-rise stage M1 followed by a constant-voltage stage M2. An operating voltage of the voltage gradual-rise stage M1 increases from an initial voltage to a target voltage, and an operating voltage of the constant-voltage stage M2 is maintained at the target voltage Vt. More specifically, the pulse-type anodizing treatment is performed with a pulse frequency from 500 Hz to 2,000 Hz and a duty cycle from 1% to 50%, the initial voltage is 0V, and the target voltage is from 50V to 600V. Furthermore, a duration of time of the voltage gradual-rise stage M1 is from 1 minute to 10 minutes, and a duration of time of the constant-voltage stage M2 is from 5 minutes to 60 minutes and more than twice the duration of time of the voltage gradual-rise stage M1. In such an operation, the surface smoothness and compactness of the anodized oxide layer 2 can be improved by controlling nucleation, growth, and dissolution rates of magnesium oxide, and the pores 200 are formed in a regular arrangement and a uniform distribution on the anodized oxide layer 2. Furthermore, compared to a general anodizing treatment, the anodizing treatment of the present disclosure is advantageous for reducing power consumption and increasing production efficiency.

In the embodiment of the present disclosure, the target voltage Vt of the pulse-type anodizing treatment can be 50V, 100V, 150V, 200V, 250V, 300V, 350V, 400V, 450V, 500V, 550V, or 600V. The pulse frequency can be 500 Hz, 600 Hz, 700 Hz, 800 Hz, 900 Hz, 1000 Hz, 1100 Hz, 1200 Hz, 1300 Hz, 1400 Hz, 1500 Hz, 1600 Hz, 1700 Hz, 1800 Hz, 1900 Hz, or 2000 Hz. The duty cycle can be 1%, 5%, 10%, 15%, 20%, 25%, 30%, 35%, 40%, 45%, or 50%.

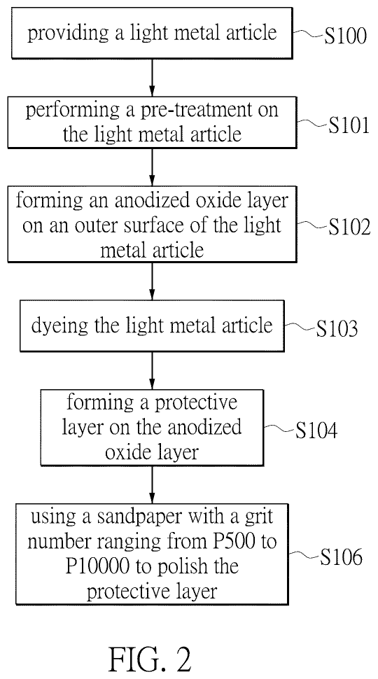

Referring to FIG. 2, the method for manufacturing the ceramic-like light metal article of the present disclosure can further include a pre-treatment step, i.e., step S101, performing a pre-treatment on the light metal article 1, before the anodizing treatment is performed. It should be noted that the means of the pre-treatment varies depending on different purposes. For example, the means of the pre-treatment can include degreasing, decarbonization, alkaline washing, acid washing, or any combination thereof, so as to remove defects, dirt, natural oxide films, and so on present on the outer surface 100 of the light metal article 1. Alternatively, the means of the pre-treatment can include polishing, sandblasting, or the combination thereof, so as to create a special surface effect.

In step S104, the protective layer 3 is formed by an electric hole-sealing treatment. In an execution process, the light metal article 1 is immersed in a resin composition, and an external electric field is applied to cause a resin component to migrate to and deposit on the light metal article 1, thereby forming a uniform coating on the anodized oxide layer 2. More specifically, the protective layer 3 is formed from a resin composition. The resin composition includes an acrylic resin and a solid powder, and can further include colorants if necessary, in which a solid content thereof is from 3 wt % to 30 wt %, thereby meeting performance requirements such as gloss, hardness, and weather resistance. The solid powder is a powder of a metal, a non-metal, or an oxide of the metal or non-metal. Specific examples of the solid powder include powders of aluminum oxide, titanium oxide, silicon dioxide, iron oxide, and tin oxide and powders of aluminum, gold, silver, and iron. The electric hole-sealing treatment is performed under an operating voltage from 1 V to 150 V for 30 seconds to 10 minutes. Afterwards, the coating adhered on the anodized oxide layer 2 can be cured by baking to form the protective layer 3, in which baking conditions include a baking temperature from 100° C. to 200° C. and a baking time from 15 minutes to 60 minutes. Furthermore, a portion of the protective layer 3 is filled into and seals the pores 200 of the anodized oxide layer 2.

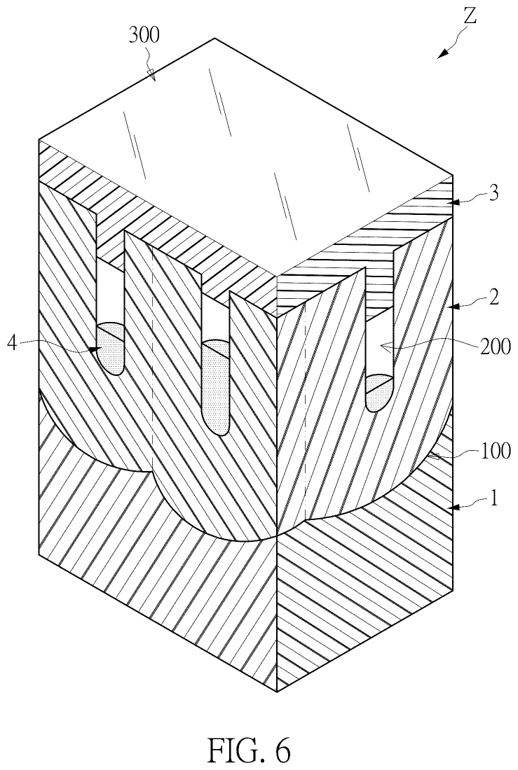

Referring to FIG. 2, which is to be read in conjunction with FIG. 4 and FIG. 6, the method for manufacturing the ceramic-like light metal article of the present disclosure can further include a step of dyeing the light metal article 1 (i.e., step S103), between the step of forming the anodized oxide layer 2 (i.e., step S102) and the step of forming the protective layer 3 (i.e., step S104). In an execution process, the light metal article 1 is immersed in a dyeing material, so that a color component 4 such as an organic colorant in the dyeing material is deposited on the anodized oxide layer 2 and at least partially fills into the pores 200. If necessary, a water washing process can be used to remove the color component 4 that is not within the pores 200. It is worth mentioning that one aspect of the present disclosure is to control the structure and arrangement of the pores 200 of the anodized oxide layer 2 under a predetermined pulse-voltage operation, which includes the voltage gradual-rise stage M1 and the constant-voltage stage M2, so that the effects of easy and more uniform dyeing can be achieved. Furthermore, in the presence of the protective layer 3, the color component 4 can be stably retained in the pores 200 of the anodized oxide layer 2 for a long period of time, so that the light metal article 1 can have a variety of color variations.

In step S106, a sandpaper with a grit number ranging from P500 to P10000 is used to polish the protective layer 3, and the grit number of P2000 is preferable, so that a surface 300 of the protective layer 3 has a gloss of not less than 90 GU at a 60 degree angle and a surface roughness (Ra) of less than 0.1 μm. Therefore, the outer surface 100 of the light metal article 1 can be ceramized and increased in gloss level. In the embodiment of the present disclosure, the sandpaper for polishing can includes abrasive particles made of garnet, silicon carbide, aluminum oxide, silicon oxide, zinc oxide and/or chromium oxide. A thickness of the protective layer 3 after being polished is reduced to 20% to 80% of an original thickness of the protective layer 3.

The method for manufacturing the ceramic-like light metal article of the present disclosure will be further explained with the following specific examples. However, said specific examples are disclosed for exemplary purposes only, and are not meant to limit the scope of the present disclosure.

### Specific Example 1

An article made of AZ91D magnesium alloy is immersed in an electrolytic solution having a pH value of 12 and a temperature of 10° C. The electrolytic solution includes potassium nitrate as an oxidant, potassium hydroxide as a pH adjusting agent, and sodium silicate as a film-forming agent. An anodizing treatment is performed with a pulse voltage of 200V, a pulse frequency of 1,000 Hz, and a duty cycle of 7%, in which a duration of time of a voltage rise stage is 5 minutes, and a duration of time of a constant-voltage treatment stage is 20 minutes. After that, an anodized oxide layer having a thickness of 20 μm is formed. The article after being anodized is immersed in a red dye solution for 15 minutes, thereby having a red appearance. The article having the red appearance is immersed in a resin composition including an acrylic resin and an aluminum oxide powder and having a total solid content of 12% for undergoing an electric hole-sealing treatment that is performed at a voltage of 20V for 5 minutes. Afterwards, a layer of the resin composition is cured by baking at 180° C. for 30 minutes. Lastly, a sandpaper with silicon oxide abrasive particles (grit number: P2000) is used to polish the cured layer, and a red high-gloss ceramic-like article having a thickness of 10 μm is thus obtained, which has a surface gloss of 95 GU at a 60 degree angle and a surface roughness (Ra) of 0.08 μm.

### Specific Example 2

An article made of AZ31B magnesium alloy is immersed in an electrolytic solution having a pH value of 13 and a temperature of 20° C. The electrolytic solution includes potassium permanganate as an oxidant, sodium hydroxide as a pH adjusting agent, and the combination of sodium hexametaphosphate and trisodium phosphate as a film-forming agent. An anodizing treatment is performed with a pulse voltage of 250V, a pulse frequency of 800 Hz, and a duty cycle of 5%, in which a duration of time of a voltage rise stage is 3 minutes, and a duration of time of a constant-voltage treatment stage is 30 minutes. After that, an anodized oxide layer having a thickness of 30 μm is formed. The article after being anodized is immersed in a resin composition including an acrylic resin and a silica powder and having a total solid content of 16% for undergoing an electric hole-sealing treatment that is performed at a voltage of 30V for 3 minutes. Afterwards, a layer of the resin composition is cured by baking at 160° C. for 60 minutes. Lastly, a sandpaper with aluminum oxide abrasive particles (grit number: P7000) is used to polish the cured layer, and a white high-gloss ceramic-like article having a thickness of 20 μm is thus obtained, which has a surface gloss of 100 GU at a 60 degree angle and a surface roughness (Ra) of 0.05 μm.

### Specific Example 3

An article made of 6063 aluminum alloy is immersed in an electrolytic solution having a pH value of 11 and a temperature of 18° C. The electrolytic solution includes sodium nitrate as an oxidant, sodium hydroxide as a pH adjusting agent, and aluminum hydroxide as a film-forming agent. An anodizing treatment is performed with a pulse voltage of 150V, a pulse frequency of 1,200 Hz, and a duty cycle of 10%, in which a duration of time of a voltage rise stage is 3 minutes, and a duration of time of a constant-voltage treatment stage is 10 minutes. After that, an anodized oxide layer having a thickness of 15 μm is formed. The article after being anodized is immersed in a blue dye solution for 30 minutes, thereby having a blue appearance. The article having the blue appearance is immersed in a resin composition including an acrylic resin and a titanium dioxide powder and having a total solid content of 10% for undergoing an electric hole-sealing treatment that is performed at a voltage of 100V for 3 minutes. Afterwards, a layer of the resin composition is cured by baking at 200° C. for 30 minutes. Lastly, a sandpaper with aluminum oxide abrasive particles (grit number: P10000) is used to polish the cured layer, and a blue high-gloss ceramic-like article having a thickness of 9 μm is thus obtained, which has a surface gloss of 92 GU at a 60 degree angle and a surface roughness (Ra) of 0.03 μm.

### Specific Example 4

An article made of pure titanium is immersed in an electrolytic solution having a pH value of 13 and a temperature of 10° C. The electrolytic solution includes potassium nitrate as an oxidant, lithium hydroxide as a pH adjusting agent, and the combination of sodium silicate and sodium hexametaphosphate as a film-forming agent. An anodizing treatment is performed with a pulse voltage of 120V, a pulse frequency of 1,500 Hz, and a duty cycle of 8%, in which a duration of time of a voltage rise stage is 2 minutes, and a duration of time of a constant-voltage treatment stage is 12 minutes. After that, an anodized oxide layer having a thickness of 10 μm is formed. The article after being anodized is immersed in a resin composition including an acrylic resin and a silver powder and having a total solid content of 14% for undergoing an electric hole-sealing treatment that is performed at a voltage of 25V for 10 minutes. Afterwards, a layer of the resin composition is cured by baking at 170° C. for 40 minutes. Lastly, a sandpaper with silicon carbide abrasive particles (grit number: P2000) is used to polish the cured layer, and a gray high-gloss ceramic-like article having a thickness of 4 μm is thus obtained, which has a surface gloss of 90 GU at a 60 degree angle and a surface roughness (Ra) of 0.08 μm.

### Beneficial Effects of the Embodiments

In conclusion, in the method for manufacturing a ceramic-like light metal article of the present disclosure, by virtue of forming an anodized oxide layer on an outer surface of the light metal article, forming a protective layer on the anodized oxide layer, using a sandpaper with a grit number ranging from P500 to P10000 to polish the protective layer, and the polished protective layer having a surface gloss of not less than 90 GU at a 60 degree angle and a surface roughness (Ra) of less than 0.1 μm, the light metal article can exhibit a variety of color variations and a ceramic-like appearance, thereby obtaining unique surface decoration effects.

More specifically, the anodizing treatment used in the method for manufacturing the ceramic-like light metal article of the present disclosure is a pulse-type anodizing treatment, which includes a voltage gradual-rise stage followed by a constant-voltage stage. In such an operation, the surface smoothness and compactness of the anodized oxide layer can be improved by controlling nucleation, growth, and dissolution rates of magnesium oxide, and the pores are formed in a regular arrangement and a uniform distribution on the anodized oxide layer. Furthermore, compared to a general anodizing treatment, the anodizing treatment of the present disclosure is advantageous for reducing power consumption and increasing production efficiency.

In addition, one aspect of the present disclosure is to control the structure and arrangement of the pores of the anodized oxide layer under a predetermined pulse-voltage operation, which includes the voltage gradual-rise stage and the constant-voltage stage, so that the effects of easy and more uniform dyeing can be achieved.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A method for manufacturing a ceramic-like light metal article, comprising:
providing a light metal article;
forming an anodized oxide layer on an outer surface of the light metal article, wherein the anodized oxide layer has a plurality of pores extending towards the outer surface of the light metal article;
forming a protective layer on the anodized oxide layer; and
using a sandpaper with a grit number ranging from P500 to P10000 to polish the protective layer, wherein the polished protective layer has a surface gloss of not less than 90 GU at a 60 degree angle and a surface roughness (Ra) of less than 0.1 μm.

2. The method according to claim 1, wherein the grit number of the sandpaper used in the step of polishing the protective layer is P2000.

3. The method according to claim 2, wherein in the step of polishing the protective layer, a thickness of the polished protective layer is reduced to 20% to 80% of an original thickness of the protective layer.

4. The method according to claim 2, wherein an anodizing treatment is performed in an electrolytic solution with a pH value ranging from 8 to 13 and a temperature ranging from 5° C. to 40° C., so as to form the anodized oxide layer; the electrolytic solution includes an oxidant, a pH adjusting agent, and a film-forming agent.

5. The method according to claim 4, wherein the oxidant is selected from the group consisting of sodium nitrate, potassium nitrate, potassium permanganate, and potassium dichromate, the pH adjusting agent is selected from the group consisting of sodium hydroxide, potassium hydroxide, lithium hydroxide, and magnesium hydroxide, and the film-forming agent is selected from the group consisting of sodium silicate, aluminum hydroxide, ammonium dihydrogen phosphate, sodium hexametaphosphate, and trisodium phosphate.

6. The method according to claim 4, wherein the anodizing treatment is a pulse-type anodizing treatment, which includes a voltage gradual-rise stage followed by a constant-voltage stage, an operating voltage of the voltage gradual-rise stage increases from an initial voltage to a target voltage, and an operating voltage of the constant-voltage stage is maintained at the target voltage.

7. The method according to claim 6, wherein the pulse-type anodizing treatment is performed with a pulse frequency from 500 Hz to 2,000 Hz and a duty cycle from 1% to 50%, the initial voltage is 0V, and the target voltage is from 50V to 600V; wherein a duration of time of the voltage gradual-rise stage is from 1 minute to 10 minutes, and a duration of time of the constant-voltage stage is from 5 minutes to 60 minutes and more than twice the duration of time of the voltage gradual-rise stage.

8. The method according to claim 1, wherein the protective layer is formed from a resin composition including an acrylic resin and a solid powder, the solid powder is a powder of a metal, a non-metal, or an oxide of the metal or non-metal, and a solid content of the resin composition is from 3 wt % to 30 wt %; the protective layer is formed by an electric hole-sealing treatment that is performed under an operating voltage from 1V to 150V for 30 seconds to 10 minutes.

9. The method according to claim 8, wherein the step for forming the protective layer further includes baking the resin composition at a temperature from 100° C. to 200° C. for 15 minutes to 60 minutes.

10. The method according to claim 1, further comprising filling the pores of the anodized oxide layer with at least one dye between the step of forming the anodized oxide layer and the step of forming the protective layer, wherein in the step of forming the protective layer, a portion of the protective layer is filled into and seals the pores of the anodized oxide layer.

11. The method according to claim 10, wherein the grit number of the sandpaper used in the step of polishing the protective layer is P2000.

12. The method according to claim 11, wherein in the step of polishing the protective layer, a thickness of the protective layer after being polished is reduced to 20% to 80% of an original thickness of the protective layer.

13. The method according to claim 10, wherein an anodizing treatment is performed in an electrolytic solution with a pH value ranging from 8 to 13 and a temperature ranging from 5° C. to 40° C., so as to form the anodized oxide layer; the electrolytic solution includes an oxidant, a pH adjusting agent, and a film-forming agent.

14. The method according to claim 13, wherein the oxidant is selected from the group consisting of sodium nitrate, potassium nitrate, potassium permanganate, and potassium dichromate, the pH adjusting agent is selected from the group consisting of sodium hydroxide, potassium hydroxide, lithium hydroxide, and magnesium hydroxide, and the film-forming agent is selected from the group consisting of sodium silicate, aluminum hydroxide, ammonium dihydrogen phosphate, sodium hexametaphosphate, and trisodium phosphate.

15. The method according to claim 10, wherein the anodizing treatment is a pulse-type anodizing treatment, which includes a voltage gradual-rise stage followed by a constant-voltage stage, an operating voltage of the voltage gradual-rise stage increases from an initial voltage to a target voltage, and an operating voltage of the constant-voltage stage is maintained at the target voltage.

16. The method according to claim 15, wherein the pulse-type anodizing treatment is performed with a pulse frequency from 500 Hz to 2,000 Hz and a duty cycle from 1% to 50%, the initial voltage is 0V, and the target voltage is from 50V to 600V; wherein a duration of time of the voltage gradual-rise stage is from 1 minute to 10 minutes, and a duration of time of the constant-voltage stage is from 5 minutes to 60 minutes and more than twice the duration of time of the voltage gradual-rise stage.

17. The method according to claim 10, wherein the protective layer is formed from a resin composition including an acrylic resin and a solid powder, the solid powder is a powder of a metal, a non-metal, or an oxide of the metal or non-metal, and a solid content of the resin composition is from 3 wt % to 30 wt %; wherein the protective layer is formed by an electric hole-sealing treatment that is performed at an operating voltage from 1V to 150V for 30 seconds to 10 minutes.

18. The method according to claim 17, wherein the step for forming the protective layer further includes baking the resin composition at a temperature from 100° C. to 200° C. for 15 minutes to 60 minutes.

19. A ceramic-like light metal article, comprising:
a light metal article;
an anodized oxide layer formed on an outer surface of the light metal article and having a plurality of pores extending towards the outer surface of the light metal article; and
a protective layer formed on the anodized oxide layer to seal the pores, wherein the protective layer has a surface gloss of not less than 90 GU at a 60 degree angle and a surface roughness (Ra) of less than 0.1 μm.
